(19) United States
(12) Patent Application Publication
(10) Pub. No.: US 2023/0369603 A1
(43) Pub. Date: Nov. 16, 2023

(54) ELECTRODES WITH RESIN LAYERS AND METHODS OF PRODUCING THE SAME

(71) Applicant: 24M Technologies, Inc., Cambridge, MA (US)

(72) Inventors: Naoki OTA, Lexington, MA (US); Junzheng CHEN, Concord, MA (US)

(21) Appl. No.: 18/195,525

(22) Filed: May 10, 2023

Related U.S. Application Data
(60) Provisional application No. 63/340,616, filed on May 11, 2022.

(51) Int. Cl. H01M 4/66; H01M 4/134; H01M 4/38; H01M 50/489; H01M 10/058; H01M 4/04; H01M 10/42

(52) U.S. Cl. CPC H01M 4/667; H01M 4/661; H01M 4/134; H01M 4/382; H01M 50/489; H01M 10/058; H01M 4/0426; H01M 10/4235

(57) ABSTRACT

In some aspects, an electrode described herein can include a resin configured to create a rise in impedance, a film coupled to a first side of the resin via an adhesive, a first portion of an electrode material disposed on a second side of the resin, and a second portion of the electrode material disposed on the second side of the resin, wherein the first portion of the current collector material does not physically contact the second portion of the current collector material. In some embodiments, the electrode can further include a first portion of a current collector material disposed between the resin and the first portion of the electrode material and a second portion of the current collector material disposed between the resin and the second portion of the electrode material.

### CROSS REFERENCE TO RELATED APPLICATIONS

This application claims the benefit of U.S. Provisional Application No. 63/340,616, titled “Electrodes with Resin Layers and Methods of Producing the Same,” and filed May 11, 2022, the disclosure of which is incorporated herein by reference in its entirety.

### TECHNICAL FIELD

Embodiments described herein relate to resin layers incorporated into electrodes and electrochemical cells.

### BACKGROUND

Short circuits and thermal runaway present significant safety concerns in electrochemical cell design. During operation, dendrites can form in electrodes and bridge the anode and cathode, causing short circuit events. Electrons rush toward the location of the short circuit, and the temperature at the short circuit location can increase significantly, causing thermal runaway and creating an ignition risk. By containing the space affected by the short circuit event, temperature increase near the short circuit location can be limited, and thermal runaway can be prevented.

### SUMMARY

In some aspects, an electrode described herein can include a resin configured to create a rise in impedance, a film coupled to a first side of the resin via an adhesive, a first portion of an electrode material disposed on a second side of the resin, and a second portion of the electrode material disposed on the second side of the resin, wherein the first portion of the current collector material does not physically contact the second portion of the current collector material. In some embodiments, the electrode can further include a first portion of a current collector material disposed between the resin and the first portion of the electrode material and a second portion of the current collector material disposed between the resin and the second portion of the electrode material. In some embodiments, the current collector material can include a copper powder, an aluminum powder, a copper-coated micro capsule, and/or an aluminum-coated microcapsule. In some embodiments, the electrode can include a third portion of the current collector material coupled to the first portion of the current collector material via a connection tab and a third portion of the electrode material disposed on the third portion of the current collector material.

### BRIEF DESCRIPTION OF THE DRAWINGS

FIG. 1 is a block diagram of an electrode, according to an embodiment.

FIGS. 2A-2C are illustrations of an electrode, according to an embodiment.

FIG. 3 is a block diagram of a method of producing an electrode, according to an embodiment.

### DETAILED DESCRIPTION

When a short circuit event occurs in an electrochemical cell, isolation of the location of the short circuit event can prevent thermal runaway and contain the damage to a discrete portion of the electrochemical cell. This can be accomplished via a resin coating on the electrode material and/or the current collector material, particularly when the current collector material is designed to act as a fuse. Resin coatings can prevent sparks inside of electrochemical cells.

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

In some embodiments, current collectors described herein can include segmented current collectors. Segmented current collectors are described in greater detail in U.S. Patent Publication No. 2021/0384516, filed Jun. 4, 2021, and titled “Electrochemical Cells with One or More Segmented Current Collectors, and Methods of Making the Same,” the disclosure of which is hereby incorporated by reference in its entirety. In some embodiments, current collectors and resins described herein can be used in combination with expanding polymers and/or gas generation materials, as described in U.S. patent application Ser. No. 17/687,242, filed Mar. 4, 2022, and titled “Overcharge Protection in Electrochemical Cells,” the disclosure of which is hereby incorporated by reference in its entirety. In some embodiments, current collectors described herein can be arranged in grid formations, as described in U.S. Pat. No. 10,181,587, filed Jun. 17, 2016, and titled “Single Pouch Battery Cells and Methods of Manufacture,” the disclosure of which is hereby incorporated by reference in its entirety.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, the terms “activated carbon network” and “networked carbon” relate to a general qualitative state of an electrode. For example, an electrode with an activated carbon network (or networked carbon) is such that the carbon particles within the electrode assume an individual particle morphology and arrangement with respect to each other that facilitates electrical contact and electrical conductivity between particles and through the thickness and length of the electrode. Conversely, the terms “unactivated carbon network” and “unnetworked carbon” relate to an electrode wherein the carbon particles either exist as individual particle islands or multi-particle agglomerate islands that may not be sufficiently connected to provide adequate electrical conduction through the electrode.

As used herein, the terms “energy density” and “volumetric energy density” refer to the amount of energy (e.g., MJ) stored in an electrochemical cell per unit volume (e.g., L) of the materials included for the electrochemical cell to operate such as, the electrodes, the separator, the electrolyte, and the current collectors. Specifically, the materials used for packaging the electrochemical cell are excluded from the calculation of volumetric energy density.

As used herein, the terms “high-capacity materials” or “high-capacity anode materials” refer to materials with irreversible capacities greater than 300 mAh/g that can be incorporated into an electrode in order to facilitate uptake of electroactive species. Examples include tin, tin alloy such as Sn—Fe, tin mono oxide, silicon, silicon alloy such as Si-Co, silicon monoxide, aluminum, aluminum alloy, mono oxide metal (CoO, FeO, etc.) or titanium oxide.

As used herein, the term “composite high-capacity electrode layer” refers to an electrode layer with both a high-capacity material and a traditional anode material, e.g., a silicon-graphite layer.

As used herein, the term “solid high-capacity electrode layer” refers to an electrode layer with a single solid phase high-capacity material, e.g., sputtered silicon, tin, tin alloy such as Sn—Fe, tin mono oxide, silicon, silicon alloy such as Si—Co, silicon monoxide, aluminum, aluminum alloy, mono oxide metal (CoO, FeO, etc.) or titanium oxide.

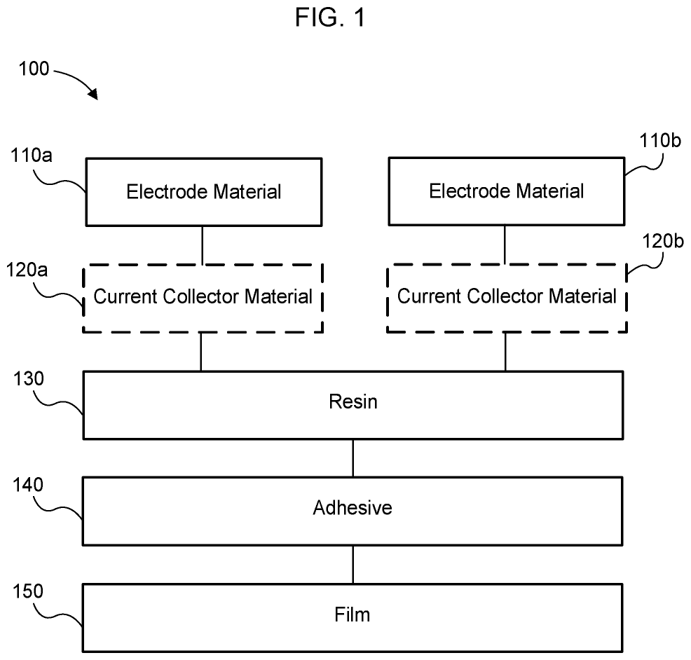

FIG. 1 is a block diagram of an electrode 100, according to an embodiment. As shown, the electrode 100 includes sections of electrode material 110a, 110b (collectively referred to as electrode material 110). The electrode 100 optionally includes sections of current collector material 120a, 120b (collectively referred to as current collector material 120) coupled to the electrode material 110. The electrode 100 further includes a resin 130 coupled to the current collector material 120 and/or the electrode material 110, an adhesive coupled to the resin 130, and a film 150 coupled to the adhesive 140.

The section of electrode material 110a can be physically separated from the section of electrode material 110b. The physical separation of the section of electrode material 110a from the section of electrode material 110b can localize or isolate short circuit events. In some embodiments, the electrode material 110 can include a semi-solid electrode. In some embodiments, the semi-solid electrode can be binderless. In some embodiments, the semi-solid electrode can include a cathode. In some embodiments, the semi-solid electrode can include an anode. In some embodiments, the semi-solid electrode material can be crushed and/or grinded prior to mixing the semi-solid electrode material with the solvent. In some embodiments, the semi-solid electrode material can be crushed and/or grinded while mixing the semi-solid electrode material with the solvent. In some embodiments, the electrode slurry can be subject to grinding and/or crushing. In some embodiments, the semi-solid electrode material can be subjected to screening prior to mixing the semi-solid electrode material with the solvent. In some embodiments, the semi-solid electrode material can be subjected to screening while mixing the semi-solid electrode material with the solvent. The screening can separate larger particles from the semi-solid electrode. In some embodiments, the electrode slurry can be subject to screening. In some embodiments, the screening can include employing a vibratory screen.

In some embodiments, the semi-solid electrode can include an anode material. In some embodiments, the anode material can include a tin metal alloy such as, for example, a Sn—Co—C, a Sn—Fe—C, a Sn—Mg—C, or a La—Ni—Sn alloy. In some embodiments, the anode material can include an amorphous oxide such as, for example, SnO or SiO amorphous oxide. In some embodiments, the anode material can include a glassy anode such as, for example, a Sn—Si—Al—B—O, a Sn—Sb—S—O, a SnO₂—P₂O₅, or a SnO—B₂O₃—P₂O₅—Al₂O₃ anode. In some embodiments, the anode material can include a metal oxide such as, for example, a CoO, a SnO₂, or a V₂O₅. In some embodiments, the anode material can include a metal nitride such as, for example, Li₃N or Li_{2.}6CoO·4N. In some embodiments, the anode material can include an anode active material selected from lithium metal, carbon, lithium-intercalated carbon, lithium nitrides, lithium alloys and lithium alloy forming compounds of silicon, bismuth, boron, gallium, indium, zinc, tin, antimony, aluminum, titanium oxide, molybdenum, germanium, manganese, niobium, vanadium, tantalum, gold, platinum, iron, copper, chromium, nickel, cobalt, zirconium, yttrium, molybdenum oxide, germanium oxide, silicon oxide, silicon carbide, any other high capacity materials or alloys thereof, and any other combination thereof. In some embodiments, the anode active material can include silicon and/or alloys thereof. In some embodiments, anode active material can include tin and/or alloys thereof.

In some embodiments, the semi-solid electrode can include a cathode material. In some embodiments, the cathode material can include the general family of ordered rocksalt compounds LiMO₂ including those having the α-NaFeO₂ (so-called “layered compounds”) or orthorhombic-LiMnO₂ structure type or their derivatives of different crystal symmetry, atomic ordering, or partial substitution for the metals or oxygen. M comprises at least one first-row transition metal but may include non-transition metals including but not limited to Al, Ca, Mg, or Zr. Examples of such compounds include LiFePO₄ (LFP), LiCoO₂, LiCoO₂ doped with Mg, LiNiO₂, Li(Ni, Co, Al)O₂ (known as “NCA”) and Li(Ni, Mn, Co)O₂ (known as “NMC”). In some embodiments, the cathode material can include a spinel structure, such as LiMn₂O₄ and its derivatives, so-called “layered-spinel nanocomposites” in which the structure includes nanoscopic regions having ordered rocksalt and spinel ordering, olivines LiMPO₄ and their derivatives, in which M comprises one or more of Mn, Fe, Co, or Ni, partially fluorinated compounds such as LiVPO₄F, other “polyanion” compounds as described below, and vanadium oxides VₓO_{y} including V₂O₅ and V₆O₁₁. In some embodiments, the cathode material can include a transition metal polyanion compound. In some embodiments, the cathode material can include an alkali metal transition metal oxide or phosphate, and for example, the compound has a composition Aₓ(M′₁₋ₐM″ₐ)_{y}(XD₄)_{z}, Aₓ(M′₁₋ₐM″ₐ)_{y}(DXD₄)_{z}, or Aₓ(M′₁₋ₐM″ₐ)_{y}(X₂D₇)_{z}, and have values such that x, plus y(1−a) times a formal valence or valences of M′, plus y(a) times a formal valence or valence of M″, is equal to z times a formal valence of the XD₄, X₂D₇, or DXD₄ group; or a compound comprising a composition (A₁₋ₐM″ₐ)ₓM′_{y}(XD₄)_{z}, (A₁₋ₐM″ₐ)ₓ(M′_{y}(DXD₄)z(A₁₋ₐM″ₐ)ₐM′_{y}(X₂D₇)_{z} and have values such that (1−a)x plus the quantity ax times the formal valence or valences of M″ plus y times the formal valence or valences of M′ is equal to z times the formal valence of the XD₄, X₂D₇ or DXD₄ group. In the compound, A is at least one of an alkali metal and hydrogen, M′ is a first-row transition metal, X is at least one of phosphorus, sulfur, arsenic, molybdenum, and tungsten, M″ any of a Group HA, IIIA, IVA, VA, VIA, VIIA, VIIIA, IB, IIB, IIIB, IVB, VB, and VIB metal, D is at least one of oxygen, nitrogen, carbon, or a halogen. The positive electroactive material can be an olivine structure compound LiMPO₄, where M is one or more of V, Cr, Mn, Fe, Co, and Ni, in which the compound is optionally doped at the Li, M or O-sites. Deficiencies at the Li-site are compensated by the addition of a metal or metalloid, and deficiencies at the O-site are compensated by the addition of a halogen. In some embodiments, the positive active material comprises a thermally stable, transition-metal-doped lithium transition metal phosphate having the olivine structure and having the formula (Li₁₋ₓZₓ)MPO₄, where M is one or more of V, Cr, Mn, Fe, Co, and Ni, and Z is a non-alkali metal dopant such as one or more of Ti, Zr, Nb, Al, or Mg, and x ranges from 0.005 to 0.05.

In some embodiments, the conductive material can include allotropes of carbon including activated carbon, hard carbon, soft carbon, Ketjen, carbon black, graphitic carbon, carbon fibers, carbon microfibers, vapor-grown carbon fibers (VGCF), fullerenic carbons including “buckyballs”, carbon nanotubes (CNTs), multiwall carbon nanotubes (MWNTs), single wall carbon nanotubes (SWNTs), graphene sheets or aggregates of graphene sheets, and materials comprising fullerenic fragments, or any combination thereof. In some embodiments, the active material, the conductive material, and/or the electrolyte solution can include any of the materials described in U.S. Pat. No. 9,437,864 (“the '864 patent”), filed Mar. 10, 2014, titled “Asymmetric Battery Having a Semi-solid Cathode and High Energy Density Anode,” the disclosure of which is hereby incorporated by reference in its entirety.

In some embodiments, the non-aqueous liquid electrolyte can include an electrolyte solvent and an electrolyte salt. In some embodiments, the electrolyte solvent can include vinylene carbonate (VC), 1,3 propane sultone (PS), ethyl propionate (EP), 1,3-propanediol cyclic sulfate (PSA/TS), fluoroethylene carbonate (FEC), ethylene sulfite (ES), tris(2-ethylhexyl) phosphate (TOP), ethylene sulfate (DTD), ethyl acetate (EA), maleic anhydride (MA), ethylene carbonate (EC), propylene carbonate (PC), dimethyl carbonate (DMC), ethyl methyl carbonate (EMC), or combinations thereof. In some embodiments, the electrolyte salt can include lithium bis(oxalato)borate (LiBOB), lithium hexafluorophosphate (LiPF₆), lithium bis(fluorosulfony)imide (LiFSI), or any combination thereof.

In some embodiments, the electrode material 110 can include a solid or conventional electrode material. In some embodiments, the electrode material 110 can include lithium metal, including lithium powder applied via coating or sputtering. In some embodiments, the solid electrode material can include a binder. In some embodiments, the first section of electrode material 110a can be the same material or a substantially similar material to the second section of electrode material 110b.

As shown, the electrode 100 includes two sections of electrode material 110. In some embodiments, the electrode 100 can include at least about 2, at least about 3, at least about 4, at least about 5, at least about 6, at least about 7, at least about 8, at least about 9, at least about 10, at least about 11, at least about 12, at least about 13, at least about 14, at least about 15, at least about 16, at least about 17, at least about 18, at least about 19, at least about 20, at least about 25, at least about 30, at least about 35, at least about 40, at least about 45, at least about 50, at least about 55, at least about 60, at least about 65, at least about 70, at least about 75, at least about 80, at least about 85, at least about 90, or at least about 95 sections of electrode material 110. In some embodiments, the electrode 100 can include no more than about 100, no more than about 95, no more than about 90, no more than about 85, no more than about 80, no more than about 75, no more than about 70, no more than about 65, no more than about 60, no more than about 55, no more than about 50, no more than about 45, no more than about 40, no more than about 35, no more than about 30, no more than about 25, no more than about 20, no more than about 19, no more than about 18, no more than about 17, no more than about 16, no more than about 15, no more than about 14, no more than about 13, no more than about 12, no more than about 11, no more than about 10, no more than about 9, no more than about 8, no more than about 7, no more than about 6, no more than about 5, no more than about 4, or no more than about 3 sections of electrode material 110. Combinations of the above-referenced numbers of sections of electrode material 110 are also possible (e.g., at least about 2 and no more than about 100 or at least about 10 and no more than about 30), inclusive of all values and ranges therebetween. In some embodiments, the electrode 100 can include about 2, about 3, about 4, about 5, about 6, about 7, about 8, about 9, about 10, about 11, about 12, about 13, about 14, about 15, about 16, about 17, about 18, about 19, about 20, about 25, about 30, about 35, about 40, about 45, about 50, about 55, about 60, about 65, about 70, about 75, about 80, about 85, about 90, about 95, or about 100 sections of electrode material 110.

The optional current collector material 120 can couple the electrode material 110 to the resin 130. In some embodiments, the current collector material 120 can have a smaller width and/or length dimension than the electrode material 110, as described in greater detail in U.S. Patent Publication No. 2021/0265631, filed Feb. 22, 2021, and titled, “Electrochemical Cells with Electrode Material Coupled Directly to Film and Methods of Making the Same,” the disclosure of which is hereby incorporated by reference in its entirety. In some embodiments, the current collector material 120 can include aluminum powder. In some embodiments, the current collector material 120 can include copper powder. In some embodiments, the current collector material 120 can include copper-coated microcapsules. In some embodiments, the current collector material 120 can include aluminum-coated microcapsules.

The resin 130 can prevent a spark from forming on the electrode material 110 or the current collector material 120. In some embodiments, the resin 130 can at least partially engulf the electrode material 110 and/or the current collector material 120 to prevent a spark from forming in the electrode material 110 and/or the current collector material 120. In some embodiments, the resin 130 can include a rubber, a ceramic, a synthetic resin, a polymer resin, a phenolic resin, an alkyd resin, a polycarbonate resin, a polyamide resin, a polyurethane resin, a silicone resin, an epoxy resin, a polyethylene resin, an acrylic resin, a polystyrene resin, a polypropylene resin, or any combination thereof.

The adhesive 140 bonds the film 150 to the resin 130. In some embodiments, the adhesive 140 can include wet adhesive, contact adhesive, reactive adhesive, single-component reactive adhesive, two-component reactive adhesives, hot-melt adhesives, pressure-sensitive adhesives, or any combination thereof.

The film 150 acts as a pouch material. In some embodiments, the film 150 can adjoin an additional film (not shown) to enclose an electrochemical cell. In some embodiments, the film 150 can be composed of polyethylene terephthalate (PET), polybutylene terephthalate (PBT), nylon, high-density polyethylene (HDPE), oriented polypropylene (o-PP), polyvinyl chloride (PVC), polyimide (PI), polysulfone (PSU), or any combinations thereof.

In some embodiments, the film 150 can have a higher melting temperature than the adhesive 140. In some embodiments, the adhesive 140 can have a higher melting temperature than the resin 130. In some embodiments, the resin can have a higher melting temperature than the current collector material 120. This cascading melting temperature scheme can aid in isolating short circuit events and heat bursts. For example, the current collector material 120 can melt, breaking electrical contact between the first section of current collector material 120a and the second section of current collector material 120b, while the resin is still intact, isolating the current collector material 120 from contact with the outer layers or the outside environment.

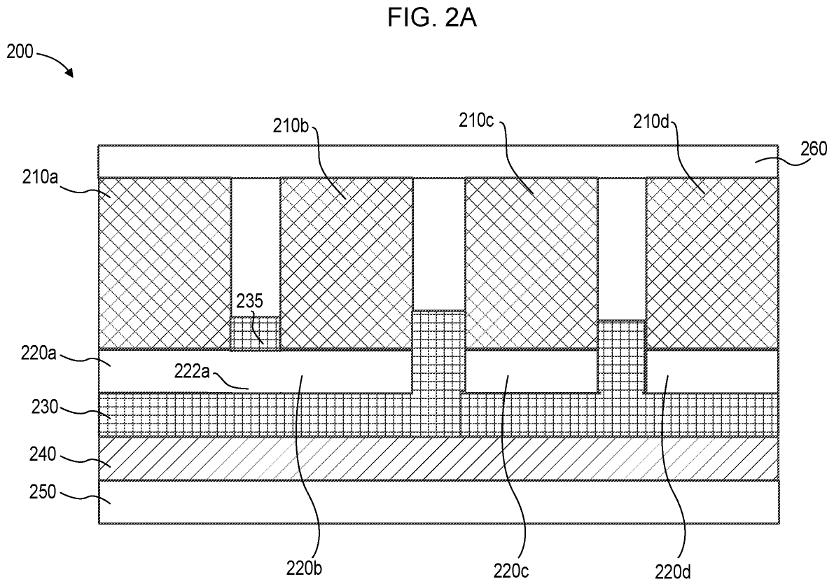

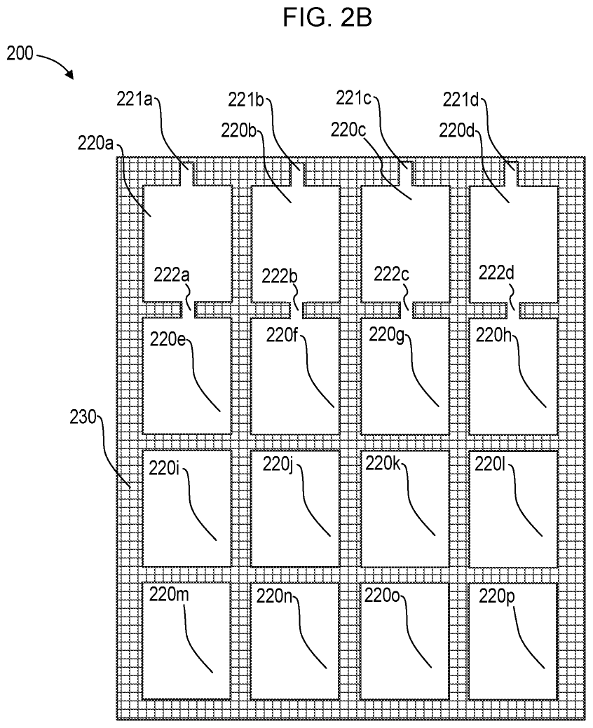

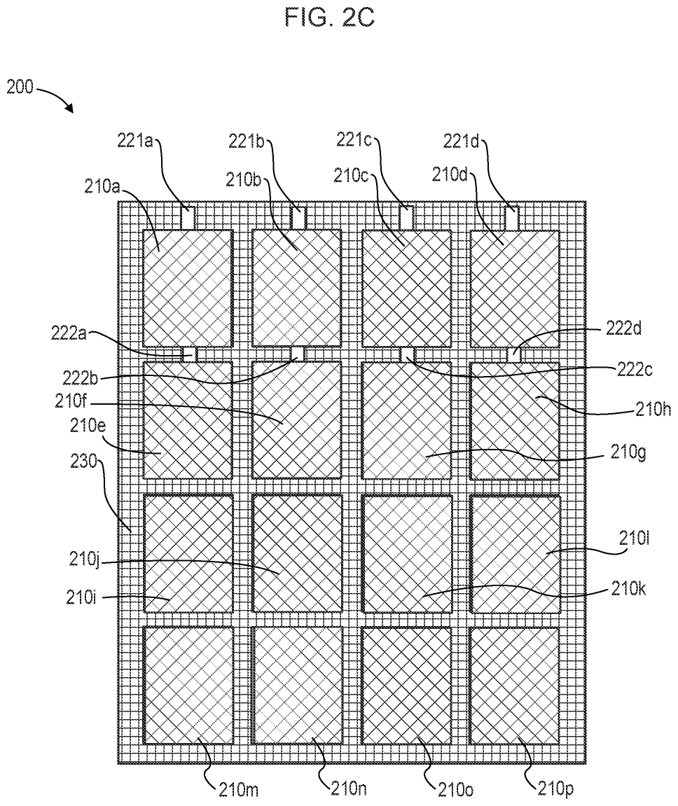

FIGS. 2A-2C are illustrations of an electrode 200, according to an embodiment. FIG. 2A shows a profile view of the electrode 200, while FIG. 2B shows an overhead view of the electrode 200 without electrode material shown, and FIG. 2C shows an overhead view of the electrode 200 with electrode material shown. As shown, the electrode 200 includes sections of electrode material 210a, 210b, 210c, 210d, 210e, 210f, 210g, 210h, 210i, 210j, 210k, 210l, 210m, 210n, 210o, 210p(collectively referred to as electrode material 210), sections of current collector material 220a, 220b, 220c, 220d, 220e, 220f, 220g, 220h, 220i, 220j, 220k, 220l, 220m, 220n, 220o, 220p (collectively referred to as current collector material 220), tabs 221a, 221b, 221c, 221d (collectively referred to as electrode tabs 221), connectors 222a, 222b, 222c, 222d (collectively referred to as connectors 222), resin 230, resin hubs 235, adhesive 240, film 250, and separator 260. In some embodiments, the electrode material 210, the current collector material 220, the resin 230, the adhesive 240, and the film 250 can be the same or substantially similar to the electrode material 110, the current collector material 120, the resin 130, the adhesive 140, and the film 150, as described above with reference to FIG. 1. Thus, certain aspects of the electrode material 210, the current collector material 220, the resin 230, the adhesive 240, and the film 250 are not described in greater detail herein.

In some embodiments, the electrode material 210 can include any of the materials described above with reference to the electrode material 110. As shown, the sections of the electrode material 210 are arranged in a 4×4 configuration. In some embodiments, the sections of the electrode material 210 can be arranged in an m×n configuration, wherein m and n are integers. In some embodiments, m and/or n can be at least about 1, at least about 2, at least about 3, at least about 4, at least about 5, at least about 6, at least about 7, at least about 8, at least about 9, at least about 10, at least about 11, at least about 12, at least about 13, at least about 14, at least about 15, at least about 16, at least about 17, at least about 18, or at least about 19. In some embodiments, m and/or n can be no more than about 20, no more than about 19, no more than about 18, no more than about 17, no more than about 16, no more than about 15, no more than about 14, no more than about 13, no more than about 12, no more than about 11, no more than about 10, no more than about 9, no more than about 8, no more than about 7, no more than about 6, no more than about 5, no more than about 4, no more than about 3, or no more than about 2. Combinations of the above-referenced values of m and n are also possible (e.g., at least about 1 and no more than about 20 or at least about 4 and no more than about 16), inclusive of all values and ranges therebetween. In some embodiments, m and/or n can be about 1, about 2, about 3, about 4, about 5, about 6, about 7, about 8, about 9, about 10, about 11, about 12, about 13, about 14, about 15, about 16, about 17, about 18, about 19, or about 20.

In some embodiments, either of the sections of electrode material 210 can have a thickness of at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1,100 μm, at least about 1,200 μm, at least about 1,300 μm, at least about 1,400 μm, at least about 1,500 μm, at least about 1,600 μm, at least about 1,700 μm, at least about 1,800 μm, or at least about 1,900 μm. In some embodiments, the electrode material 210 can have a thickness of no more than about 2,000 μm, no more than about 1,900 μm, no more than about 1,800 μm, no more than about 1,700 μm, no more than about 1,600 μm, no more than about 1,500 μm, no more than about 1,400 μm, no more than about 1,300 μm, no more than about 1,200 μm, no more than about 1,100 μm, no more than about 1,000 μm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, or no more than about 30 μm. Combinations of the above-referenced thickness values of the electrode material 210 are also possible (e.g., at least about 20 μm and no more than about 2,000 μm or at least about 100 μm and no more than about 1,000 μm), inclusive of all values and ranges therebetween. In some embodiments, the electrode material 210 can have a thickness of about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1,100 μm, about 1,200 μm, about 1,300 μm, about 1,400 μm, about 1,500 μm, about 1,600 μm, about 1,700 μm, about 1,800 μm, about 1,900 μm, or about 2,000 μm.

In some embodiments, electrode material 210 can include active material coated only onto the current collector material 220. In other words, the electrode material 210 can be coated onto the current collector material 220 without extending over the edges of the current collector material 220. This can aid in the isolation of a short-circuited electrode. In such cases, current can be prevented from flowing through the active material when a short circuit event occurs.

As shown, the sections of current collector material 220 are arranged in a 4×4 pattern. In some embodiments, the sections of current collector material 220 can be arranged in an m×n pattern, wherein m×n can have the same ranges as those described above with reference to the electrode material 210. In some embodiments, current collectors 220 formed from the current collector material can have a thickness of at least about 2 μm, at least about 2.5 μm, at least about 3 μm, at least about 3.5 μm, at least about 4 μm, at least about 4.5 μm, at least about 5 μm, at least about 5.5 μm, at least about 6 μm, at least about 6.5 μm, at least about 7 μm, at least about 7.5 μm, at least about 8 μm, at least about 8.5 μm, at least about 9 μm, or at least about 9.5 μm. In some embodiments, current collectors 220 formed from the current collector material can have a thickness of no more than about 10 μm, no more than about 9.5 μm, no more than about 9 μm, no more than about 8.5 μm, no more than about 8 μm, no more than about 7.5 μm, no more than about 7 μm, no more than about 6.5 μm, no more than about 6 μm, no more than about 5.5 μm, no more than about 5 μm, no more than about 4.5 μm, no more than about 4 μm, no more than about 3.5 μm, no more than about 3 μm, or no more than about 2.5 μm. Combinations of the above-referenced thicknesses of the current collectors formed from the current collector material 220 are also possible (e.g., at least about 2 μm and no more than about 10 μm or at least about 4 μm and no more than about 8 μm), inclusive of all values and ranges therebetween. In some embodiments, current collectors 220 formed from the current collector material can have a thickness of about 2 μm, about 2.5 μm, about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, or about 10 μm.

In some embodiments, the current collector material 220 can have a melting temperature (at atmospheric pressure) of at least about 50° C., at least about 55° C., at least about 60° C., at least about 65° C., at least about 70° C., at least about 75° C., at least about 80° C., at least about 85° C., at least about 90° C., or at least about 95° C. In some embodiments, the current collector material 220 can have a melting temperature of no more than about 100° C., no more than about 95° C., no more than about 90° C., no more than about 85° C., no more than about 80° C., no more than about 75° C., no more than about 70° C., no more than about 65° C., no more than about 60° C., or no more than about 55° C. Combinations of the above-referenced melting temperatures are also possible (e.g., at least about 50° C. and no more than about 100° C. or at least about 60° C. and no more than about 90° C.), inclusive of all values and ranges therebetween. In some embodiments, the current collector material 220 can have a melting temperature of about 50° C., about 55° C., about 60° C., about 65° C., about 70° C., about 75° C., about 80° C., about 85° C., about 90° C., about 95° C., or about 100° C.

The tabs 221 can connect the electrode 200 to a voltage source. In some embodiments, the tabs 221 can be welded to the current collector material 220. The connectors 222 can act as fuses. As the temperature in the resin 230 and the current collector material 220 increases, the connectors 222 can melt, breaking contact between adjacent sections of current collector material 220. In some embodiments, the connectors 222 can have thicknesses the same or substantially similar to the current collectors formed from the current collector material 220. In some embodiments, the connectors 222 can have widths of at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, or at least about 900 μm. In some embodiments, the connectors 222 can have widths of no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9 μm, no more than about 8 μm, no more than about 7 μm, no more than about 6 μm, no more than about 5 μm, no more than about 4 μm, no more than about 3 μm, or no more than about 2 μm. Combinations of the above-referenced widths of the connectors 222 are also possible (e.g., at least about 1 μm and no more than about 1 mm or at least about 20 μm and no more than about 40 μm), inclusive of all values and ranges therebetween. In some embodiments, the connectors 222 can have widths of about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 80 μm, about 90 μm, about 100 μm, about 200 μm, about 300 μm, about 400 μm, about 500 μm, about 600 μm, about 700 μm, about 800 μm, about 900 μm, or about 1 mm.

As shown, the connectors 222 connect a portion of the sections of the current collector material 220. More specifically, the connectors 222 connect the current collector material 220a to the current collector material 220e, the current collector material 220b to the current collector material 220f, the current collector material 220c to the current collector material 220g, and the current collector material 220d to the current collector material 220h. In some embodiments, the connectors 222 can connect all of the sections of the current collector material 220. In some embodiments, the connectors 222 can connect any combination of the sections of the current collector material 220. For example, the current collector material 220a can be connected to the current collector material 220b, the current collector material 220b can be connected to the current collector material 220c, the current collector material 220c can be connected to the current collector material 220d, the current collector material 220e can be connected to the current collector material 220f, the current collector material 220f can be connected to the current collector material 220g, the current collector material 220g can be connected to the current collector material 220h, the current collector material 220i can be connected to the current collector material 220j, the current collector material 220j can be connected to the current collector material 220k, the current collector material 220k can be connected to the current collector material 220l, the current collector material 220m can be connected to the current collector material 220n, the current collector material 220n can be connected to the current collector material 220o, the current collector material 220o can be connected to the current collector material 220p, the current collector material 220a can be connected to the current collector material 220e, the current collector material 220e can be connected to the current collector material 220i, the current collector material 220i can be connected to the current collector material 220m, the current collector material 220b can be connected to the current collector material 220f, the current collector material 220f can be connected to the current collector material 220j, the current collector material 220j can be connected to the current collector material 220n, the current collector material 220c can be connected to the current collector material 220g, the current collector material 220g can be connected to the current collector material 220k, the current collector material 220k can be connected to the current collector material 220o, the current collector material 220d can be connected to the current collector material 220h, the current collector material 220h can be connected to the current collector material 220l, the current collector material 220l can be connected to the current collector material 220p, and any combination thereof.

As shown, the resin 230 extends beyond they outer edges of the sections of current collector material 220. In some embodiments, the resin 230 can have a thickness greater than the thickness of the current collector material 220 and the connectors 222, as shown in FIG. 2A, where the resin hub 235 extends to a space between the electrode material 210a and the electrode material 210b at a height greater than the thickness of the connector 222. In some embodiments, the resin 230 can have a thickness of at least about 0.5 μm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, or at least about 90 μm. In some embodiments, the resin 230 can have a thickness of no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, or no more than about 1 μm. Combinations of the above-referenced thicknesses of the resin 230 are also possible (e.g., at least about 0.5 μm and no more than about 100 μm or at least about 10 μm and no more than about 50 μm), inclusive of all values and ranges therebetween. In some embodiments, the resin 230 can have a thickness of about 0.5 μm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, or about 100 μm.

In some embodiments, the resin 230 can have a melting temperature of at least about 50° C., at least about 55° C., at least about 60° C., at least about 65° C., at least about 70° C., at least about 75° C., at least about 80° C., at least about 85° C., at least about 90° C., or at least about 95° C. In some embodiments, the resin 230 can have a melting temperature of no more than about 100° C., no more than about 95° C., no more than about 90° C., no more than about 85° C., no more than about 80° C., no more than about 75° C., no more than about 70° C., no more than about 65° C., no more than about 60° C., or no more than about 55° C. Combinations of the above-referenced melting temperatures are also possible (e.g., at least about 50° C. and no more than about 100° C. or at least about 60° C. and no more than about 90° C.), inclusive of all values and ranges therebetween. In some embodiments, the resin 230 can have a melting temperature of about 50° C., about 55° C., about 60° C., about 65° C., about 70° C., about 75° C., about 80° C., about 85° C., about 90° C., about 95° C., or about 100° C.

The resin hubs 235 are portions of the resin 230 that extend into regions between the sections of electrode material 210. In some embodiments, the resin hubs 235 can engulf the connectors 222 to prevent sparks and/or ignition. In other words, the connectors 222 can be prevented from contacting gases that can fuel ignition when the resin 230 and the resin hubs 235 engulf the connectors 222. In some embodiments, the connectors 222 can have a lower melting temperature than the resin 230, such that the connectors melt 222 while the resin 230 and the resin hubs 235 are still intact.

In some embodiments, the adhesive 240 can have a melting temperature of at least about 80° C., at least about 85° C., at least about 90° C., at least about 95° C., at least about 100° C., at least about 105° C., at least about 110° C., at least about 115° C., at least about 120° C., at least about 125° C., at least about 130° C., at least about 135° C., at least about 140° C., or at least about 145° C. In some embodiments, the adhesive 240 can have a melting temperature of no more than about 150° C., no more than about 145° C., no more than about 140° C., no more than about 135° C., no more than about 130° C., no more than about 125° C., no more than about 120° C., no more than about 115° C., no more than about 110° C., no more than about 105° C., no more than about 100° C., no more than about 95° C., no more than about 90° C., or no more than about 85° C. Combinations of the above-referenced melting temperatures are also possible (e.g., at least about 80° C. and no more than about 150° C. or at least about 120° C. and no more than about 150° C.), inclusive of all values and ranges therebetween. In some embodiments, the adhesive 240 can have a melting temperature of about 80° C., about 85° C., about 90° C., about 95° C., about 100° C., about 105° C., about 110° C., about 115° C., about 120° C., about 125° C., about 130° C., about 135° C., about 140° C., about 145° C., or about 150° C.

In some embodiments, the adhesive 240 can have a thickness of at least about 2 μm, at least about 2.5 μm, at least about 3 μm, at least about 3.5 μm, at least about 4 μm, at least about 4.5 μm, at least about 5 μm, at least about 5.5 μm, at least about 6 μm, at least about 6.5 μm, at least about 7 μm, at least about 7.5 μm, at least about 8 μm, at least about 8.5 μm, at least about 9 μm, or at least about 9.5 μm. In some embodiments, the adhesive 240 can have a thickness of no more than about 10 μm, no more than about 9.5 μm, no more than about 9 μm, no more than about 8.5 μm, no more than about 8 μm, no more than about 7.5 μm, no more than about 7 μm, no more than about 6.5 μm, no more than about 6 μm, no more than about 5.5 μm, no more than about 5 μm, no more than about 4.5 μm, no more than about 4 μm, no more than about 3.5 μm, no more than about 3 μm, or no more than about 2.5 μm. Combinations of the above-referenced thicknesses of the adhesive 240 are also possible (e.g., at least about 2 μm and no more than about 10 μm or at least about 2 μm and no more than about 4 μm), inclusive of all values and ranges therebetween. In some embodiments, the adhesive 240 can have a thickness of about 2 μm, about 2.5 μm, about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, or about 10 μm.

In some embodiments, the film 250 can have a melting temperature of at least about 200° C., at least about 250° C., at least about 300° C., at least about 350° C., at least about 400° C., at least about 450° C., at least about 500° C., or at least about 550° C. In some embodiments, the film 250 can have a melting temperature of no more than about 600° C., no more than about 550° C., no more than about 500° C., no more than about 450° C., no more than about 400° C., no more than about 350° C., no more than about 300° C., or no more than about 250° C. Combinations of the above-referenced melting temperatures of the film 250 are also possible (e.g., at least about 200° C. and no more than about 600° C. or at least about 300° C. and no more than about 500° C.), inclusive of all values and ranges therebetween. In some embodiments, the film 250 can have a melting temperature of about 200° C., about 250° C., about 300° C., about 350° C., about 400° C., about 450° C., about 500° C., about 550° C., or about 600° C.

In some embodiments, the film 250 can have a thickness of at least about 6 μm, at least about 6.5 μm, at least about 7 μm, at least about 7.5 μm, at least about 8 μm, at least about 8.5 μm, at least about 9 μm, at least about 9.5 μm, at least about 10 μm, at least about 10.5 μm, at least about 11 μm, or at least about 11.5 μm. In some embodiments, the film 250 can have a thickness of no more than about 12 μm, no more than about 11.5 μm, no more than about 11 μm, no more than about 10.5 μm, no more than about 10 μm, no more than about 9.5 μm, no more than about 9 μm, no more than about 8.5 μm, no more than about 8 μm, no more than about 7.5 μm, no more than about 7 μm, or no more than about 6.5 μm. Combinations of the above-referenced thicknesses of the film 250 are also possible (e.g., at least about 6 μm and no more than about 12 μm or at least about 6 μm and no more than about 8 μm), inclusive of all values and ranges therebetween. In some embodiments, the film 250 can have a thickness of about 6 μm, about 6.5 μm, about 7 μm, about 7.5 μm, about 8 μm, about 8.5 μm, about 9 μm, about 9.5 μm, about 10 μm, about 10.5 μm, about 11 μm, about 11.5 μm, or about 12 μm.

The separator 260 is disposed on the sections of electrode material 210. In some embodiments, the separator 260 can include a shutdown separator. In other words, the separator 260 can include a shutdown mechanism incorporated into it. For example, as the temperature in the electrode 200 increases, the separator 260 or a portion of the separator 260 can melt and at least a portion of the pores of the separator 260 can close, stopping further ion transport and current flow through the separator 260.

In some embodiments, each of the sections of electrode material 210 can have a capacity of at least about 0.1 Ah, at least about 0.2 Ah, at least about 0.3 Ah, at least about 0.4 Ah, at least about 0.5 Ah, at least about 0.6 Ah, at least about 0.7 Ah, at least about 0.8 Ah, at least about 0.9 Ah, at least about 1 Ah, at least about 2 Ah, at least about 3 Ah, at least about 4 Ah, at least about 5 Ah, at least about 6 Ah, at least about 7 Ah, at least about 8 Ah, or at least about 9 Ah. In some embodiments, each of the sections of electrode material 210 can have a capacity of no more than about 10 Ah, no more than about 9 Ah, no more than about 8 Ah, no more than about 7 Ah, no more than about 6 Ah, no more than about 5 Ah, no more than about 4 Ah, no more than about 3 Ah, no more than about 2 Ah, no more than about 1 Ah, no more than about 0.9 Ah, no more than about 0.8 Ah, no more than about 0.7 Ah, no more than about 0.6 Ah, no more than about 0.5 Ah, no more than about 0.4 Ah, no more than about 0.3 Ah, or no more than about 0.2 Ah. Combinations of the above-referenced capacities are also possible (e.g., at least about 0.1 Ah and no more than about 10 Ah or at least about 1 Ah and no more than about 5 Ah), inclusive of all values and ranges therebetween. In some embodiments, each of the sections of electrode material 210 can have a capacity of about 0.1 Ah, about 0.2 Ah, about 0.3 Ah, about 0.4 Ah, about 0.5 Ah, about 0.6 Ah, about 0.7 Ah, about 0.8 Ah, about 0.9 Ah, about 1 Ah, about 2 Ah, about 3 Ah, about 4 Ah, about 5 Ah, about 6 Ah, about 7 Ah, about 8 Ah, about 9 Ah, or about 10 Ah.

In some embodiments, the electrode 200 can have a capacity of at least about 10 Ah, at least about 20 Ah, at least about 30 Ah, at least about 40 Ah, at least about 50 Ah, at least about 60 Ah, at least about 70 Ah, at least about 80 Ah, at least about 90 Ah, at least about 100 Ah, at least about 200 Ah, at least about 300 Ah, at least about 400 Ah, at least about 500 Ah, at least about 600 Ah, at least about 700 Ah, at least about 800 Ah, or at least about 900 Ah. In some embodiments, the electrode 200 can have a capacity of no more than about 1,000 Ah, no more than about 900 Ah, no more than about 800 Ah, no more than about 700 Ah, no more than about 600 Ah, no more than about 500 Ah, no more than about 400 Ah, no more than about 300 Ah, no more than about 200 Ah, no more than about 100 Ah, no more than about 90 Ah, no more than about 80 Ah, no more than about 70 Ah, no more than about 60 Ah, no more than about 50 Ah, no more than about 40 Ah, no more than about 30 Ah, or no more than about 20 Ah. Combinations of the above-referenced capacities of the electrode 200 are also possible (e.g., at least about 10 Ah and no more than about 1,000 Ah or at least about 50 Ah and no more than about 500 Ah), inclusive of all values and ranges therebetween. In some embodiments, the electrode 200 can have a capacity of about 10 Ah, about 20 Ah, about 30 Ah, about 40 Ah, about 50 Ah, about 60 Ah, about 70 Ah, about 80 Ah, about 90 Ah, about 100 Ah, about 200 Ah, about 300 Ah, about 400 Ah, about 500 Ah, about 600 Ah, about 700 Ah, about 800 Ah, about 900 Ah, or about 1,000 Ah.

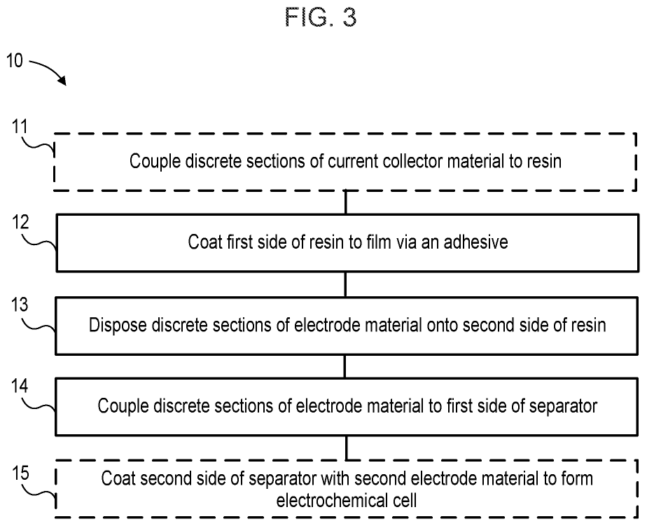

FIG. 3 is a block diagram of a method 10 of producing an electrode, according to an embodiment. As shown, the method 10 optionally includes coupling discrete sections of a current collector material to a resin at step 11. The method 10 further includes coating a first side of the resin to a film via an adhesive at step 12, disposing discrete sections of electrode material onto a second side of the resin at step 13, and coupling discrete sections of electrode material to a first side of a separator at step 14. The method 10 optionally includes coating a second side of the separator with a second electrode material to form an electrochemical cell at step 15.

Step 11 is optional and includes coupling discrete sections of current collector material to a resin. In some embodiments, the discrete sections of current collector material can be joined by fuses or connectors. In some embodiments, the discrete sections of current collector material can be physically isolated from one another. In some embodiments, some of the discrete sections of current collector material can be joined by fuses or connectors, while some of the discrete sections of current collector material can be physically isolated from one another. In some embodiments, the current collector material can include a powder. In some embodiments, the current collector material can include a copper powder, an aluminum powder, a copper-coated micro capsule, and/or an aluminum-coated microcapsule. In some embodiments, the discrete sections of current collector material can be coated onto the resin via inkjet printing, gravure coating, die coating, transfer coating, or any combination thereof. In some embodiments, the current collector material can become at least partially engulfed in resin during the coupling. In some embodiments, step 11 can include heating the resin to make the resin more malleable.

Step 12 includes coating a first side of the resin to a film via an adhesive. In some embodiments, the adhesive can be a wet adhesive, a contact adhesive, a reactive adhesive, a single-component reactive adhesive, a two-component reactive adhesive, a hot-melt adhesive, a pressure-sensitive adhesive, or any combination thereof. In some embodiments, the adhesive can be applied to the resin. In some embodiments, the adhesive can be applied to the film. In some embodiments, the film can be composed of polyethylene terephthalate (PET), polybutylene terephthalate (PBT), nylon, high-density polyethylene (HDPE), oriented polypropylene (o-PP), polyvinyl chloride (PVC), polyimide (PI), polysulfone (PSU), or any combinations thereof.

Step 13 includes disposing discrete sections of electrode material onto a second side of the resin. In some embodiments, the discrete sections of electrode material can be disposed directly onto the resin. In some embodiments, if current collector material is present, the discrete sections of electrode material can be disposed onto the sections of current collector material. In some embodiments, the discrete sections of electrode material can include cathode material. In some embodiments, the discrete sections of electrode material can include anode material. In some embodiments, the discrete sections of electrode material can include a solid or conventional electrode material with a binder. In some embodiments, the discrete sections of electrode material can include semi-solid electrode material.

Step 14 includes coupling the discrete sections of electrode material to the first side of a separator to form a first electrode. In some embodiments, the separator can include any suitable separator that acts as an ion-permeable membrane. In other words, the separator allows exchange of ions while maintaining physical separation of the cathode and the anode. For example, the separator can be any conventional membrane that is capable of ion transport. In some embodiments, the separator is a liquid impermeable membrane that permits the transport of ions therethrough, namely a solid or gel ionic conductor. In some embodiments the separator is a porous polymer membrane infused with a liquid electrolyte that allows for the shuttling of ions between the cathode and anode electroactive materials, while preventing the transfer of electrons. In some embodiments, the separator can be a microporous membrane that prevents particles forming the positive and negative electrode compositions from crossing the membrane. For example, the membrane materials can be selected from polyethyleneoxide (PEO) polymer in which a lithium salt is complexed to provide lithium conductivity, or Nation™ membranes which are proton conductors. For example, PEO based electrolytes can be used as the membrane, which is pinhole-free and a solid ionic conductor, optionally stabilized with other membranes such as glass fiber separators as supporting layers. PEO can also be used as a slurry stabilizer, dispersant, etc. in the positive or negative redox compositions. PEO is stable in contact with typical alkyl carbonate-based electrolytes. This can be especially useful in phosphate-based cell chemistries with cell potential at the positive electrode that is less than about 3.6 V with respect to Li metal. The operating temperature of the redox cell can be elevated as necessary to improve the ionic conductivity of the membrane. In some embodiments, the separator can include polyethylene, polypropylene, polyimide, or any combination thereof. In some embodiments, the separator can include a shutdown separator.

Step 15 is optional and includes coating a second side of the separator with a second electrode material to form an electrochemical cell. In some embodiments, the second electrode can include a grid layout with multiple discrete sections of electrode material, similar to the first electrode. In some embodiments, the second electrode can include a single section of electrode material. In some embodiments, the second electrode can have a length and width dimension larger than a length and width dimension of the first electrode. In some embodiments, the first electrode and/or the second electrode material can include multiple layers. Further descriptions of electrodes with multiple layers are described in greater detail in U.S. Patent Publication No. 2019/0363351, filed May 24, 2019 and titled, “High Energy-Density Composition-Gradient Electrodes and Methods of Making the Same,” the disclosure of which is hereby incorporated by reference in its entirety.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisional s, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrode, comprising:
a resin configured to create a rise in impedance;
a film coupled to a first side of the resin via an adhesive;
a first portion of an electrode material disposed on a second side of the resin; and
a second portion of the electrode material disposed on the second side of the resin,
wherein the first portion of the current collector material does not physically contact the second portion of the current collector material.

2. The electrode of claim 1, further comprising:
a first portion of a current collector material disposed between the resin and the first portion of the electrode material; and
a second portion of the current collector material disposed between the resin and the second portion of the electrode material.

3. The electrode of claim 2, wherein the current collector material includes at least one of a copper powder, an aluminum powder, a copper-coated micro capsule, or an aluminum-coated microcapsule.

4. The electrode of claim 2, further comprising:
a third portion of the current collector material coupled to the first portion of the current collector material via a connection tab; and
a third portion of the electrode material disposed on the third portion of the current collector material.

5. The electrode of claim 2, wherein the film has a higher melting temperature than the adhesive, the adhesive has a higher melting temperature than the resin, and the resin has a higher melting temperature than the current collector material.

6. The electrode of claim 2, wherein the first portion of the current collector material and the second portion of the current collector material are each rectangular in shape.

7. The electrode of claim 1, wherein the electrode material includes a semi-solid electrode material, the semi-solid electrode material including an active material and a conductive material in a non-aqueous liquid electrolyte, the semi-solid electrode material substantially free of binder.

8. The electrode of claim 1, wherein the electrode material includes lithium metal coated directly onto the resin.

9. The electrode of claim 1, further comprising:
a shutdown separator disposed on the electrode material.

10. The electrode of claim 1, wherein the electrode material includes a binder.

11. The electrode of claim 1, wherein the electrode material is a cathode material.

12. The electrode of claim 1, wherein the resin includes at least one of a rubber, a ceramic, a synthetic resin, a polyester resin, a phenolic resin, an alkyd resin, a polycarbonate resin, a polyamide resin, a polyurethane resin, a silicone resin, an epoxy resin, a polyethylene resin, an acrylic resin, a polystyrene resin, or a polypropylene resin.

13. A method, comprising:
coating a first side of resin onto film via an adhesive, the resin configured to create an impedance;
disposing a plurality of discrete sections of electrode material onto a second side of the resin, the discrete sections of electrode material physically isolated from each other; and
coupling a separator to the discrete sections of electrode material.

14. The method of claim 13, further comprising:
coupling discrete sections of current collector material to the resin, wherein disposing the plurality of discrete sections of electrode material onto the second side of the resin includes coating the discrete sections of electrode material onto the discrete sections of current collector material.

15. The method of claim 14, wherein the current collector material includes at least one of a copper powder, an aluminum powder, a copper-coated micro capsule, or an aluminum-coated microcapsule.

16. The method of claim 13, wherein the electrode material is a first electrode material and the discrete portions of the first electrode material are coupled to a first side of the separator, the method further comprising:
coating a second electrode material to a second surface of the separator.

17. The method of claim 13, wherein the electrode material is a cathode material.

18. The method of claim 13, wherein the separator is a shutdown separator.

19. The method of claim 13, wherein disposing the discrete sections of electrode material onto the second side of the resin is via sputtering.

20. The method of claim 13, further comprising:
stencil coating the resin such that the electrode material is prevented from coating to portions of the resin.

21. The method of claim 14, wherein the current collector material is applied to the resin via at least one of inkjet printing, gravure coating, die coating, or transfer coating.
